(19) United States
(12) Patent Application Publication
(10) Pub. No.: US 2004/0232396 A1
(43) Pub. Date: Nov. 25, 2004

(54) Stand-up hoisting apparatus

(76) Inventor: Shou Ming-Hwa, Hsin Tien City (TW)

Correspondence Address: LAW OFFICE OF LIAUH & ASSOC., 4224 WAIALAE AVE, STE 5-388, HONOLULU, HI, 96816

(21) Appl. No.: 10/873,863

(22) Filed: Jun. 21, 2004

Related U.S. Application Data
(63) Continuation-in-part of application No. 09/976,231, filed on Oct. 11, 2001, now abandoned.

(51) Int. Cl. B60P 1/48

(52) U.S. Cl. 254/8 R; 212/901

(57) ABSTRACT

A hoisting apparatus capable of standing alone and allowing erection by consumers is provided for use beside a bed and/or a bathtub to hoisting a patient. When the hoisting apparatus is designed for use at a patient's bedside, it includes three legs arranged in the form of a letter T. And, when the hoisting apparatus is designed for use beside a bathtub, it includes at a lower end two legs arranged in the form of a letter L, and at a higher position a rest mechanism for resting on a top of the bathtub. The two lower legs and the higher rest mechanism also provide a T-shaped support to the hoisting apparatus. The hoisting apparatus also includes a pivoted-arm mechanism capable of turning sideward as well as upward and downward, and a hanger pivotally connected to a front end of the pivoted-arm mechanism.

This is a continuation-in-part application of the U.S. patent application Ser. No. 09/976,231 filed on Oct. 11, 2001.

### FIELD OF THE INVENTION

The present invention relates to a stand-up hoisting apparatus including legs that enable the whole hoisting apparatus to stably stand up without the need of being fixedly mounted to a wall or floor, so that the apparatus may be conveniently relocated as needed. With only some simple changes in its structure, the hoisting apparatus may be conveniently used at different places, such as beside a bed or a bathtub.

### BACKGROUND OF THE INVENTION

A bedside hoisting apparatus is conventionally designed to fixedly mount to a wall or floor adjacent to one side of a sickbed to assist moving of an ill abed patient or an aged person between the sickbed and a wheelchair or other medical equipment either in a hospital or at home. Thus, a bedside hoisting apparatus not only enables a bedside attendant to take care and move the patient or the aged in an energy-saving manner, but also protects the patient or the aged against injury or impact in the course of moving. Moreover, to enable convenient and safe moving of the ill abed patient or the aged person into or from a bathtub, it is also necessary to provide the hoisting apparatus in a bathroom beside the bathtub.

All the currently available hoisting apparatus, either for use beside a bed or a bathtub, are wall-mount type. That is, these hoisting apparatus are fixedly mounted to wall or floor and have the advantage of compact volume to occupy only a small room. However, the wall-mount hoisting apparatus are immovable once they are mounted to the wall or floor. To protect the patient and the aged from impact and falling, the hoisting apparatus must have strong structure and be firmly attached to the wall or the floor to safely support the weight of the patient or the aged. In many developed countries, such as the United States, only a certified professional is allowed to install the wall-mount type bedside hoisting apparatus.

When the sickbed is to be moved to a different place, the bedside hoisting apparatus has to be dismounted from the wall or the floor and re-mounted on a wall or floor in the vicinity of the relocated sickbed by the certified professional. It is time-consuming to do so and would increase the user's burden.

### SUMMARY OF THE INVENTION

It is therefore a primary object of the present invention to provide a stand-up hoisting apparatus that could stand independently and stably without the need of mounting to a wall or floor. A consumer could purchase the hoisting apparatus and install the same by himself. The hoisting apparatus of the present invention is therefore more convenient and flexible for use.

Another object of the present invention is to provide a stand-up hoisting apparatus that could be erected for use not only in a room beside a bed, but also in a bathroom beside a bathtub.

To achieve the above and other objects, the stand-up hoisting apparatus of the present invention mainly includes a base; three legs fixedly connected an inner ends to the base to stably support the entire hoisting apparatus; a pivoted-arm mechanism that can be rotated clockwise and counterclockwise as well as turned upward and downward relative to the base; and a hanger pivotally connected to a front end of the pivoted-arm mechanism for holding a hoisting carriage to carry and move a patient.

In the stand-up hoisting apparatus of the present invention, one of the three legs is forward extended from a front side of the base, while the other two are extended from two lateral sides of the base in two opposite directions, so that the three legs are arranged in the form of a letter T.

In the stand-up hoisting apparatus of the present invention, one of the two laterally extended legs may be replaced with a rest mechanism, which is, however, located at a position higher than the remaining laterally extended leg for resting on a top of a bathtub, so that the hoisting apparatus may be erected beside a bathtub.

Moreover, the base of the hoisting apparatus of the present invention is provided with an upright hollow column, into which a lower end of a rotary shaft of the pivoted-arm mechanism is inserted for the pivoted-arm mechanism to rotate clockwise and counterclockwise relative to the upright column. The upright column is provided at a top rear edge with an axial projection, and the rotary shaft is provided on an outer surface with a radial projection adapted to abut on two lateral ends of the axial projection on the upright column, so that the rotary shaft is rotatable within in a range defined by the axial and the radial projection to avoid collision of the hoisted patient with an adjacent wall.

In the stand-up hoisting apparatus of the present invention, the hanger is pivotally connected to the front end of the pivoted-arm mechanism via a pivot joint, so that the hanger is sideward as well as upward and downward turnable relative to the pivoted-arm mechanism, enabling easy orientation of the hoisted patient to a desired position before completely lowering the patient.

In the stand-up hoisting apparatus of the present invention, the two legs extended from two lateral sides of the base can be pivotally turned to a folded position to closely locate at two sides of the leg forward extended from the front side of the base, and the pivoted-arm mechanism may be easily disassembled from the base, making the whole hoisting apparatus more convenient for transporting.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a stand-up hoisting apparatus according to an embodiment of the present invention;

FIG. 2 is a fragmentary view of FIG. 1 showing a base of the hoisting apparatus with two side legs separated therefrom;

FIG. 3 is a side view of the hoisting apparatus of FIG. 1;

FIG. 4 is an enlarged cross section taken on line 4-4 of FIG. 3;

FIG. 5 is a fragmentary and enlarged view of FIG. 1 showing the hanger and the suspension arm of the hoisting apparatus of the present invention;

FIG. 6 is a fragmentary and enlarged view of FIG. 1 showing two side legs of the hoisting apparatus of the present invention in a folded position;

FIG. 7 is an assembled perspective view of a stand-up hoisting apparatus according to another embodiment of the present invention;

FIG. 8 is a partially exploded perspective view of FIG. 7;

FIG. 9 shows the use of the hoisting apparatus of FIG. 7 beside a bathtub; and

FIG. 10 is a fragmentary enlarged sectioned side view of FIG. 9.

### DETAILED DESCRIPTION OF THE PREFERRED EMBODIMENTS

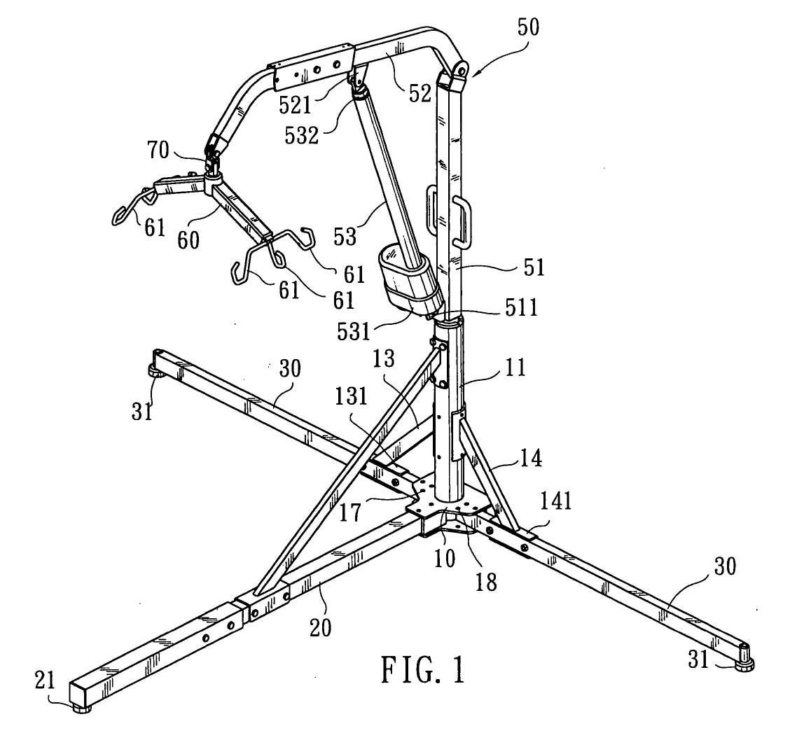

Please refer to FIGS. 1, 2, and 3 in which a stand-up hoisting apparatus according to an embodiment of the present invention is shown. The hoisting apparatus mainly includes a base 10, a front leg 20, two side legs 30, a pivoted-arm mechanism 50, and a hanger 60.

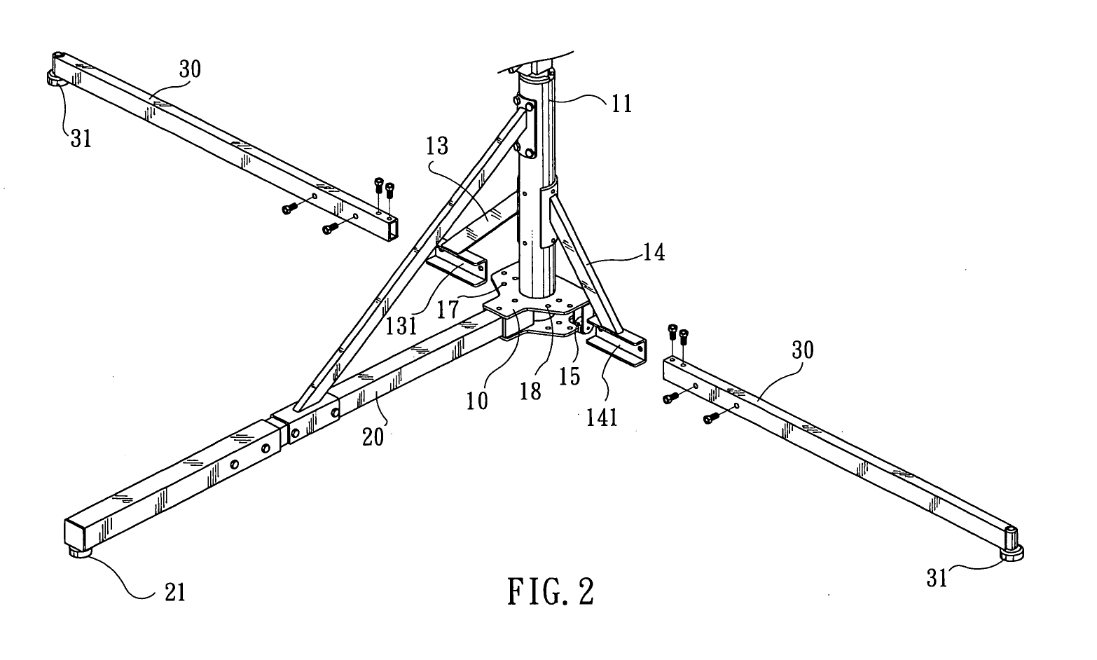

Please refer to FIG. 2 that is a fragmentary enlarged view of FIG. 1 showing the two side legs 30 are separated from the base 10. The base 10 is provided with an upright column 11 that defines a central shaft hole 12; two braces 13, 14 downward and outward extended from two lateral sides of the upright column 11 and having two forward-opened brackets 131, 141, respectively, fixedly connected to lower outer ends thereof for the two side legs 30 to extend therethrough and be screwed thereto before being screwed to the base 10; and two wheels 15 spaced below the base 10 (only one is shown in FIG. 2) to facilitate convenient moving of the base 10 and provide supporting force to the base 10 when the hoisting apparatus is in use and sinks the base 10.

The front leg 20 and the two side legs 30 are connected at their respective inner ends to the base 10 with fastening means. The front leg 20 extends forward from the base 10 and the two side legs 30 extend sideward from the base 10 in two opposite directions, so that the three legs 20, 30 are arranged in the form of a letter T. All the three legs 20, 30 are provided at their respective lower outer ends with a height-adjustable support 21, 31, respectively, to provide sufficient supporting force for the entire hoisting apparatus to stand stably.

The purpose for the three legs 20, 30 to extend in the form of a letter T is to adapt the entire hoisting apparatus to most places at where the hoisting apparatus is employed to hoist a patient. That is, it is usually to locate the two side legs 30 alongside a wall and the front leg 20 alongside a bedside. The column 11 is provided at a top rear edge with an axial projection 16 to serve as a stopper (see FIG. 4), the function of which will be described latter.

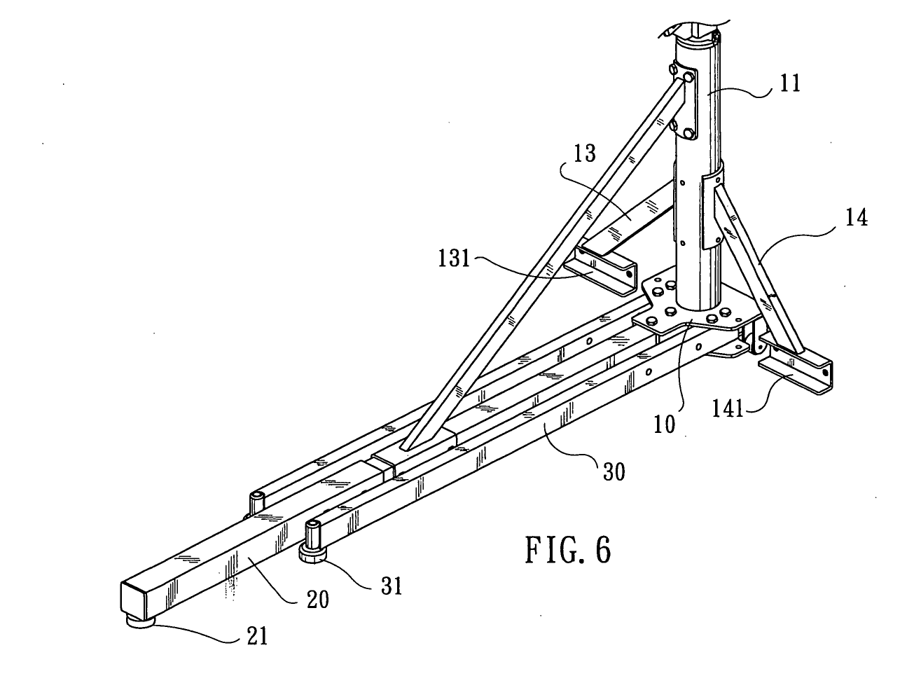

The two side legs 30 are extended through the forward-opened brackets 131, 141 and connected at an inner end to the base 10 with fastening means. The side legs 30 may be separated from the forward-opened brackets 131, 141 and turned into a folded position to locate at two sides of the front leg 20, so that the three legs 20, 30 occupy only a very small space, as shown in FIG. 6. To hold the two side legs 30 to the folded position, the base 10 is correspondingly provided with through holes 17, 18, through which fastening means may be extended to lock the side legs 30 to two sides of the front leg 20.

The front leg 20 is a two-section leg, a front section of which may be telescopically received in a rear section to adjust an overall length of the front leg 20, as shown in FIG. 2.

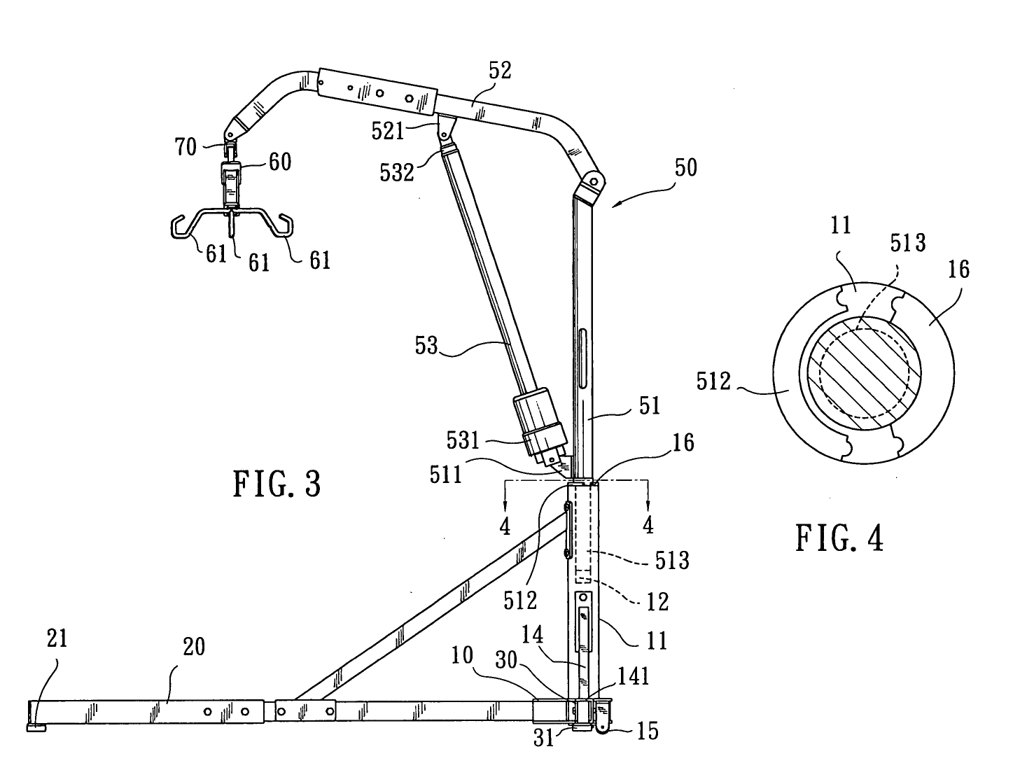

Please refer back to FIGS. 1 and 3. The pivoted-arm mechanism 50 is mounted on the base 10 and includes a rotary shaft 51, a suspension arm 52, and an extension mechanism 53. The rotary shaft 51 forms a lower part of the pivoted-arm mechanism 50 and has a lower end formed into an extended shaft 513, which is rotatably inserted into the shaft hole 12 of the upright column 11 on the base 10 to enable the rotary shaft 51 to turn clockwise and counterclockwise about the extended shaft 513. The suspension arm 52 is pivotally connected at a rear end to an upper end of the rotary shaft 51 so as to turn upward and downward relative to the rotary shaft 51. The extension mechanism 53 includes a main body 531 pivotally connected to a connecting bracket 511 forward projected from a lower part of the rotary shaft 51 (see FIG. 3), and an extension tube 532 extended from the main body 531 and having an outer end pivotally connected to two connecting lugs 521 projected from the suspension arm 52. When the extension tube 532 is driven to extend from or retract into the main body 531 of the extension mechanism 53, the suspension arm 52 is caused to turn upward or downward relative to the rotary shaft 51 and the base 10.

As can be seen from FIGS. 3 and 4, the rotary shaft 51 is provided at an outer surface with a radial projection 512 corresponding to the axial projection 16 provided on the top rear edge of the upright column 11. The radial projection 512 would be in contact with two lateral ends of the axial projection 16 to limit a rotating angle of the rotary shaft 51. That is, the axial projection 16 and the radial projection 512 together define a safe range for the rotary shaft 51 to turn clockwise and counterclockwise, so that a patient hoisted on the hoisting apparatus of the present invention would not collide with the wall alongside which the two side legs 30 of the hoisting apparatus are positioned. The whole pivoted-arm mechanism 50 can be easily disassembled from the base 10, allowing the whole hoisting apparatus of the present invention to have a relatively small volume to facilitate convenient transporting of the hoisting apparatus.

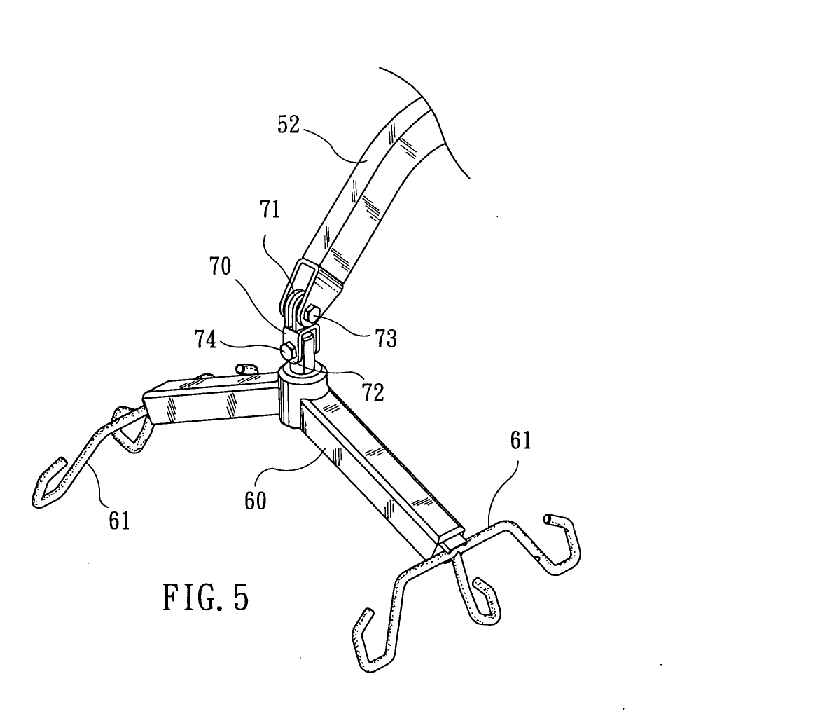

Please refer to FIGS. 1, 3, and 5. The hanger 60 is a conventional device having claws 61 provided at outer ends of two arms thereof for hanging a hoisting carriage (not shown) therefrom. The hanger 60 is pivotally connected at a top to a front end of the suspension arm 52 via a pivot joint 70.

The pivot joint 70 includes an upper end 71 pivotally connected to the front end of the suspension arm 52 at a pivot point 73, and a lower end 72 pivotally connected to the top of the hanger 60 at a pivot joint 74, so that the pivot joint 70 is forward and backward turnable relative to the pivot point 73, and the two arms of the hanger 60 are turnable upward and downward relative to the pivot point 74. This arrangement enables lowering of the hoisted patient toward a sickbed in desired position and direction. When the hoisted patient is lowered with his or her hips in contact with the sickbed, the hanger 60 may be pivotally turned relative to the suspension arm 52 while the latter is still in the process of lowering. In this manner, it is not need to move the patient any further once the patient has been completely lowered onto the sickbed. The patient is therefore well protected from undesired pull or push while being moved between the sickbed and a wheelchair or other medical equipment.

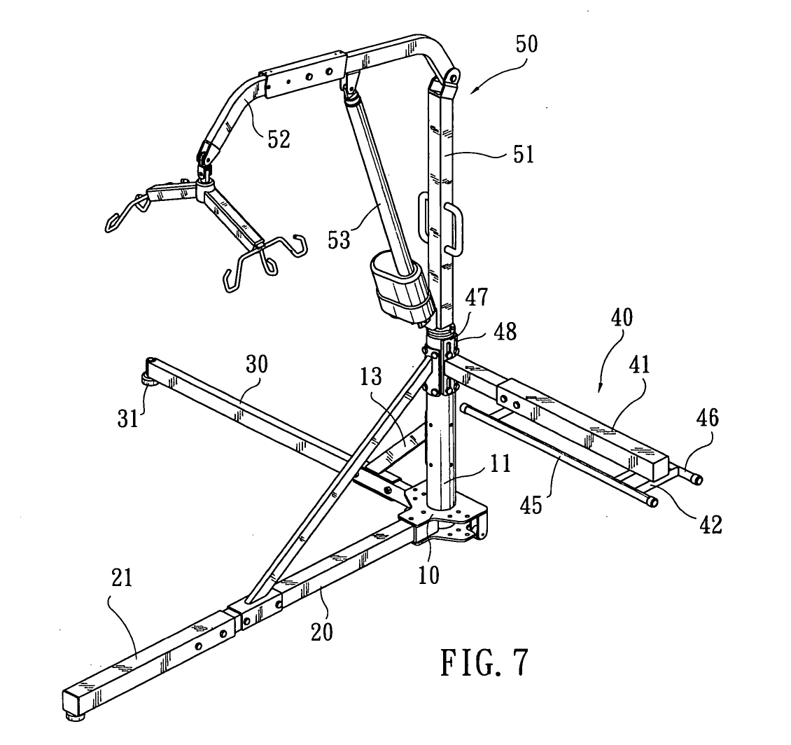

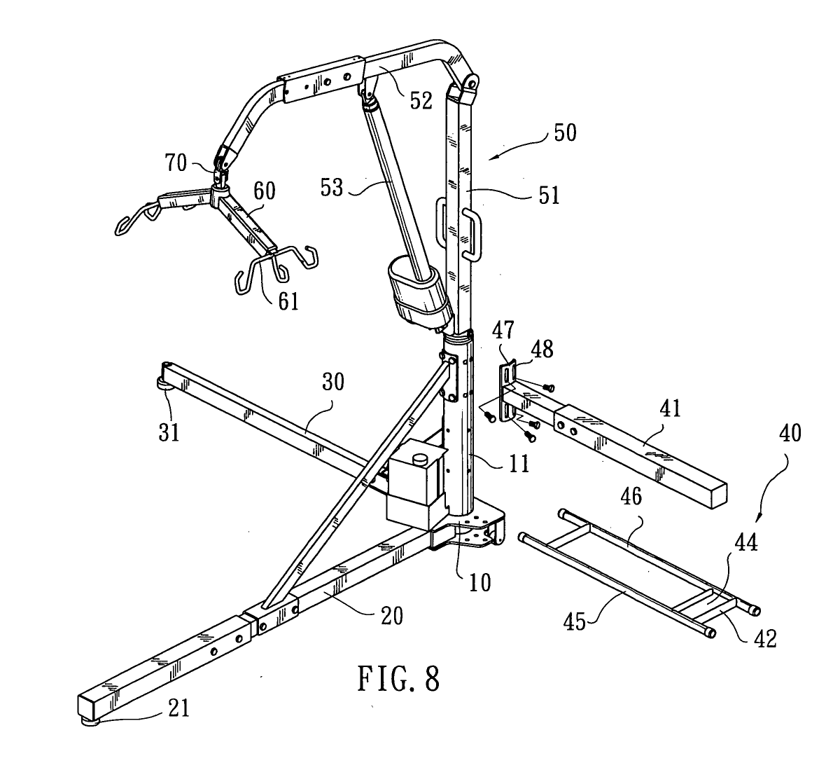

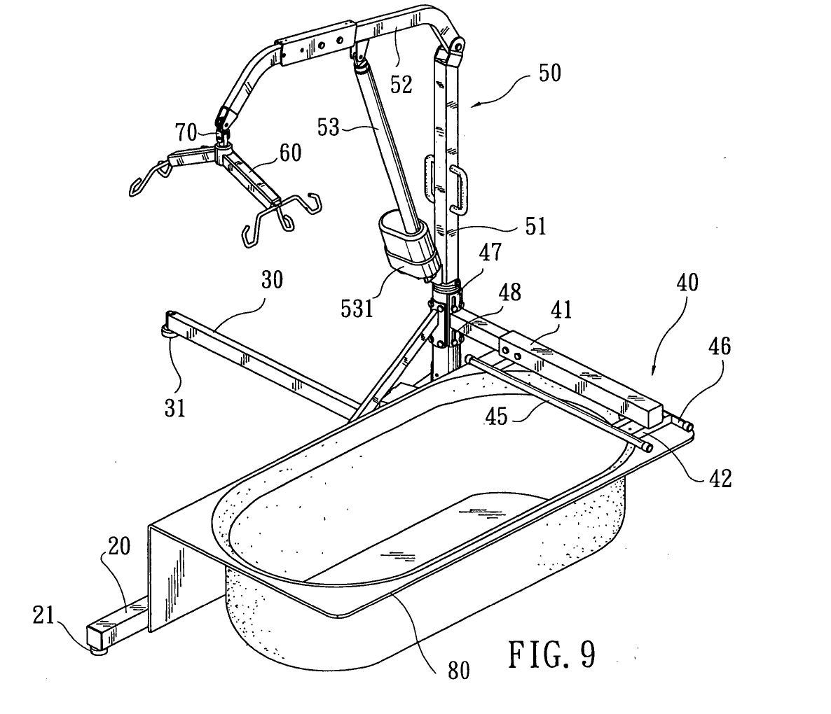

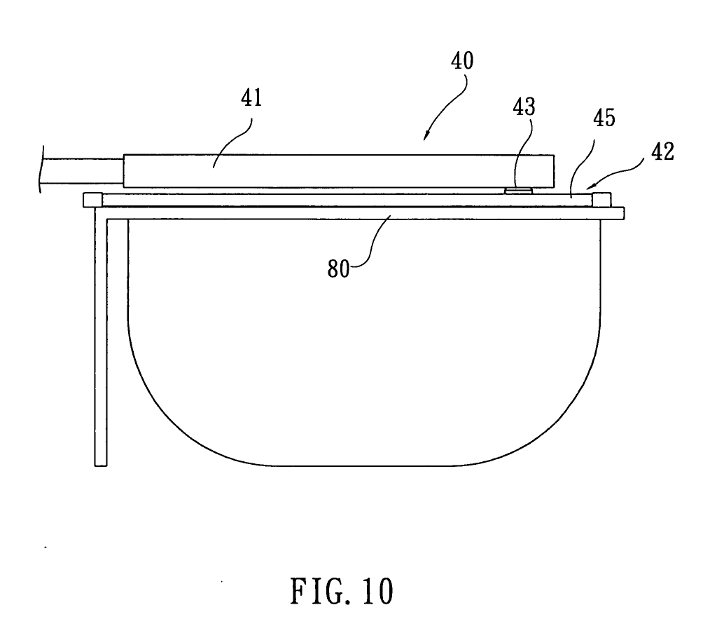

FIGS. 7 and 8 shows a stand-up hoisting apparatus according to another embodiment of the present invention. In the first embodiment, the hoisting apparatus of the present invention includes three legs 20, 30 arranged in the form of a letter T, so that the stand-up hoisting apparatus may be positioned alongside a wall for use at a patient's bedside. In the second embodiment, the stand-up hoisting apparatus is adapted for use in a bathroom to one side of a bathtub 80, as shown in FIGS. 9 and 10. For the hoisting apparatus to be used at one side of the bathtub 80, one of the two side legs 30 and a corresponding brace, which is the brace 14 in the illustrated embodiment, that extend toward the bathtub 80 are removed, so that the remaining side leg 30 and the front leg 20 together form an L-shaped supporting mechanism; and a horizontal arm 41 is fixed to the upright column 11 on the base 10 to extend toward the bathtub 80. A rest 42 is provided below the horizontal arm 41 for resting on a top of the bathtub 80. The horizontal arm 41 and the rest 42 together form a rest mechanism 40 for resting on the bathtub. As can be seen from FIG. 10, the horizontal arm 41 has a height-adjustable supporting leg 43 screwed to a lower outer end of the horizontal arm 41, which is adapted to produce a hold-down effect on the rest 42. Please refer to FIG. 8, the rest 42 may include, for example, a central bearing surface 44 and two bars 45, 46 connected to a front and a rear edge, respectively, of the bearing surface 44. When the bearing surface 44 is subjected to a pressure applied thereto by the supporting leg 43 below the horizontal arm 41, the pressure is evenly distributed to the two bars 45, 46, so that the rest 42 provides a stable supporting effect. It is to be noted that the bathtub 80 referred to in the present invention is a bathtub that has been fixed to a wall in the bathroom.

The horizontal arm 41 is connected at an inner end to the upright column 11 via a curved mounting plate 47 vertically attached to the inner end of the horizontal arm 41. The curved mounting plate 47 is formed with vertically extended long holes 48, through which fastening means may be screwed into the upright column 11. With the long holes 48, the horizontal arm 41 may be easily adjusted to a desired height on the column 11 to adapt to bathtubs of different heights. The supporting leg 43 below the horizontal arm 41 also serves as a means for finely adjusting the height of the horizontal arm 41 relative to the bathtub 80.

The stand-up hoisting apparatus of the present invention can be easily erected and transported to allow consumers to erect it independently, and therefore provides enhanced flexibility and convenience in use. Moreover, the stand-up hoisting apparatus of the present invention may be conveniently used beside a bed or a bathtub with only some simple changes in its structure.

What is claimed is:

1. A stand-up hoisting apparatus, comprising
a base being provided at a top with an upright column that defines a central shaft hole, and at a front side with a forward extended front leg and at two lateral sides with two side legs extended in two opposite directions, so that said front leg and said two side legs are arranged in the form of a letter T;
a pivoted-arm mechanism mounted on said base and including a rotary shaft, a suspension arm, and an extension mechanism; said suspension arm being pivotally connected at a rear end to an upper end of said rotary shaft, so that said suspension arm is upward and downward turnable relative to said rotary shaft when said extension mechanism is operated; and
a hanger pivotally connected to a front end of said suspension arm of said pivoted-arm mechanism via a pivot joint;
wherein said rotary shaft of said pivoted-arm mechanism is provided at a lower end with an extended shaft for rotatably inserting into said central shaft hole of said upright column on said base, and said two side legs and said front leg arranged in the form of a letter T together stably support said whole hoisting apparatus.

2. The stand-up hoisting apparatus as claimed in claim 1, wherein said upright column on said base includes two lateral braces downward and outward extended from two lateral sides of said upright column, said two braces being provided at their respective lower ends with two forward-opened U-shaped brackets, such that said two side legs are extended through said two forward-opened U-shaped brackets and screwed thereto before being fixed to said base.

3. The stand-up hoisting apparatus as claimed in claim 1, wherein said upright column on said base is provided at a top rear edge with an axial projection, and said rotary shaft of said pivoted-arm mechanism being provided on an outer surface with a radial projection corresponding to said axial projection; said radial projection being in contact with two lateral ends of said axial projection on said upright column to thereby limit a rotating angle of said rotary shaft relative to said base.

4. The stand-up hoisting apparatus as claimed in claim 1, wherein said base is provided at a bottom with two wheels.

5. A stand-up hoisting apparatus, comprising
a base being provided at a top with an upright column that defines a central shaft hole; at a front side with a forward extended front leg and at one of two lateral sides with a sideward extended side leg, so that said side leg and said front leg are arranged in the form of a letter L; and at a predetermined position on said upright column with a rest mechanism extended in a direction opposite to said side leg for resting on a top of a bathtub;
a pivoted-arm mechanism mounted on said base and including a rotary shaft, a suspension arm, and an extension mechanism; said suspension arm being pivotally connected at a rear end to an upper end of said rotary shaft, so that said suspension arm is upward and downward turnable relative to said rotary shaft when said extension mechanism is operated; and
a hanger pivotally connected to a front end of said suspension arm of said pivoted-arm mechanism via a pivot joint;
wherein said rotary shaft of said pivoted-arm mechanism is provided at a lower end with an extended shaft portion for rotatably inserting into said central shaft hole of said upright column on said base, and said front and said side leg together with said rest mechanism stably support said whole hoisting apparatus.

6. The stand-up hoisting apparatus as claimed in claim 5, wherein said rest mechanism for resting on the top of a bathtub includes a horizontal arm fixed at an inner end to said upright column on said base, and a rest for resting on the top of the bathtub; said horizontal arm having a height-adjustable supporting leg screwed to a lower outer end of said horizontal arm to produce a hold-down pressure against said rest.

7. The stand-up hoisting apparatus as claimed in claim 5, wherein said side leg is horizontally received in and screwed to a forward-opened U-shaped bracket, which is fixedly connected to said upright column, before being fixed to said base.

8. The stand-up hoisting apparatus as claimed in claim 5, wherein said upright column on said base is provided at a top rear edge with an axial projection, and said rotary shaft of said pivoted-arm mechanism being provided on an outer surface with a radial projection corresponding to said axial projection; said radial projection being in contact with two lateral ends of said axial projection on said upright column to thereby limit a rotating angle of said rotary shaft relative to said base.

9. The stand-up hoisting apparatus as claimed in claim 5, wherein said base is provided at a bottom with two wheels.
